(19) United States
(12) Patent Application Publication
(10) Pub. No.: US 2019/0078839 A1
(43) Pub. Date: Mar. 14, 2019

(54) TRANSPORT REFRIGERATION UNIT AND METHOD OF OPERATING

(71) Applicant: Carrier Corporation, Palm Beach Gardens, FL (US)

(72) Inventor: Jian Sun, Fayetteville, NY (US)

(21) Appl. No.: 16/083,768

(22) PCT Filed: Mar. 8, 2017
(86) PCT No.: PCT/US2017/021326

§ 371 Date: Sep. 10, 2018

Related U.S. Application Data
(60) Provisional application No. 62/306,471, filed on Mar. 10, 2016.

(51) Int. Cl. F25D 29/00; B60H 1/32; F25B 41/04

(52) U.S. Cl. CPC F25D 29/003; B60H 1/00271; F25B 41/043; B60H 1/3232

(57) ABSTRACT

A transport refrigeration unit (10) is provided and includes a refrigeration cycle having a refrigerant routed there through, the refrigeration cycle including a compressor (20), a condenser (22), an evaporator (26) and an expansion valve (40). Also included is an engine (32) operatively coupled to a generator (34) to power the compressor (20). Further included is an inlet structure receiving an inlet air stream (52) for routing to the engine (32). Yet further included is a cooling coil arrangement (54) disposed within the inlet structure, the refrigerant of the refrigeration cycle selectively routed through the cooling coil arrangement (54) to cool the inlet air stream (52).

### BACKGROUND OF THE DISCLOSURE

The embodiments herein generally relate to transport refrigeration units and, more particularly, to an engine inlet air chilling system for use with such transport refrigeration units.

Refrigerated trucks and trailers are commonly used to transport perishable cargo, such as, for example, produce, meat, poultry, fish, dairy products, cut flowers, and other fresh or frozen perishable products. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

In an all electric transport refrigeration system, a prime mover, most commonly a diesel engine, carried on and considered part of the transport refrigeration system, drives an AC synchronous generator that generates AC power. The generated AC power is used to power an electric compressor motor for driving the refrigerant compressor of the transport refrigeration unit and also powering electric AC fan motors for driving the condenser and evaporator motors and electric heaters associated with the evaporator.

In engine-generator driven systems, engine power decreases with increasing intake air temperature. For example, it has been observed in some systems that a 10 degree (F.) intake air temperature increase can result in a 2-3% engine power loss. In high temperature ambient conditions, the engine suffers the worst power loss while the truck-trailer unit demands the highest cooling capacity. Conventionally, a suction modulation valve is used to reduce the capacity in order to meet the engine power limits. The undesirable effects of this conventional approach are a larger engine size design requirement and inefficient operation caused by the suction modulation valves, for example.

### BRIEF DESCRIPTION OF THE DISCLOSURE

According to one embodiment, a transport refrigeration unit is provided and includes a refrigeration cycle having a refrigerant routed therethrough, the refrigeration cycle including a compressor, a condenser, an evaporator and an expansion valve. Also included is an engine operatively coupled to a generator to power the compressor. Further included is an inlet structure receiving an inlet air stream for routing to the engine. Yet further included is a cooling coil arrangement disposed within the inlet structure, the refrigerant of the refrigeration cycle selectively routed through the cooling coil arrangement to cool the inlet air stream.

In addition to one or more of the features described above, or as an alternative, further embodiments may include that the refrigerant is separated into a first stream and a second stream upstream of an evaporator inlet, the first stream routed to the evaporator and the second stream routed to the inlet structure.

In addition to one or more of the features described above, or as an alternative, further embodiments may include that the ratio of the first stream to the second stream is selectively determined by operation of an inlet coil modulation valve disposed upstream of the inlet structure.

In addition to one or more of the features described above, or as an alternative, further embodiments may include that all of the refrigerant is routed to an evaporator inlet and the refrigerant expelled from an evaporator outlet is routed to the inlet structure.

In addition to one or more of the features described above, or as an alternative, further embodiments may include an inlet coil modulation valve disposed between the evaporator outlet and the inlet structure to regulate an amount of refrigerant routed to the inlet structure.

In addition to one or more of the features described above, or as an alternative, further embodiments may include that the compressor is directly driven by an electric motor, the electric motor powered by the generator.

In addition to one or more of the features described above, or as an alternative, further embodiments may include at least one suction modulation valve disposed between an evaporator outlet and a compressor inlet.

In addition to one or more of the features described above, or as an alternative, further embodiments may include that the at least one suction modulation valve is only operated as a supplement during cooling of the inlet air stream.

In addition to one or more of the features described above, or as an alternative, further embodiments may include that the generator powers a condenser fan and an evaporator fan.

According to another embodiment, a method of operating a transport refrigeration unit is provided. The method includes powering a compressor of a refrigerant cycle with a generator driven by an engine. The method also includes ingesting an inlet air stream into the engine. The method further includes cooling the inlet air stream with a cooling coil arrangement disposed within an inlet structure disposed upstream of the engine.

In addition to one or more of the features described above, or as an alternative, further embodiments may include regulating the flow of the refrigerant to the inlet structure with an inlet coil modulating valve disposed upstream of the inlet structure.

In addition to one or more of the features described above, or as an alternative, further embodiments may include separating the refrigerant into a first stream and a second stream upstream of an evaporator, the first stream routed to the evaporator and the second stream routed to the inlet structure.

In addition to one or more of the features described above, or as an alternative, further embodiments may include routing all of the refrigerant to an evaporator and the refrigerant expelled from an evaporator outlet is routed to the inlet structure.

In addition to one or more of the features described above, or as an alternative, further embodiments may include that the compressor is directly driven by an electric motor powered by the generator.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a schematic illustration of a transport refrigeration unit system according to one aspect of the disclosure; and

FIG. 2 is a schematic illustration of the transport refrigeration unit system according to another aspect of the disclosure.

### DETAILED DESCRIPTION OF THE DISCLOSURE

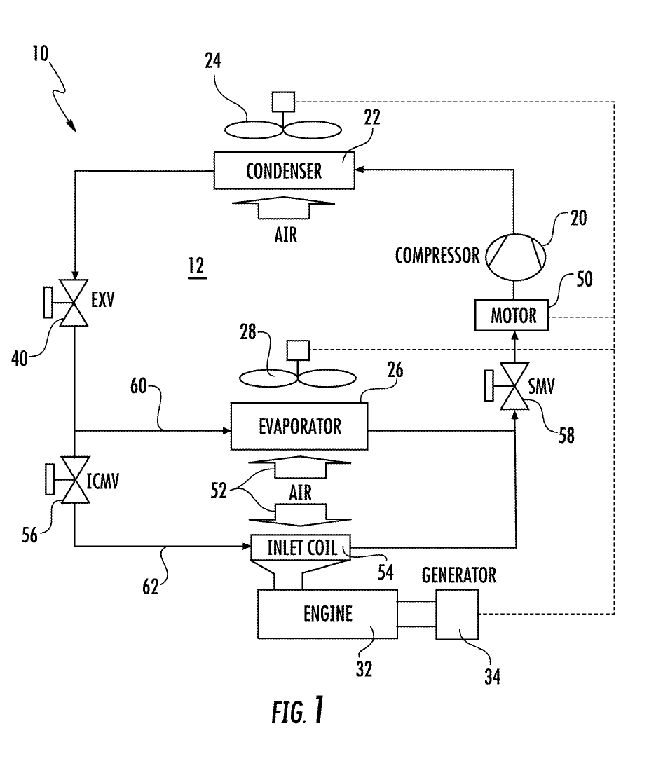

Referring to FIG. 1, a transport refrigeration unit system (TRU system) is schematically illustrated and referenced generally with numeral 10. The TRU system 10 controls temperature within a container 12. In particular, the TRU system 10 is configured to maintain a prescribed thermal environment within the container 12 (e.g., cargo in an enclosed volume). The components of the TRU system 10 described herein may be contained in an enclosed or partially enclosed volume, with the components coupled to the container at any suitable location.

The TRU system 10 can operate to induct air at a first temperature and to exhaust air at a second temperature. In one embodiment, the exhaust air from the TRU system 10 will be warmer than the inducted air such that the TRU system 10 is employed to warm the air in the container 12. In one embodiment, the exhaust air from the TRU system 10 will be cooler than the inducted air such that the TRU system 10 is employed to cool the air in the container 12.

The TRU system 10 can be used with a trailer, an intermodal container, a train railcar, a ship or the like, used for the transportation or storage of goods requiring a temperature controlled environment such as, for example, foodstuffs and medicines (e.g., perishable or frozen).

As shown in the illustrated embodiment of FIG. 1, the TRU system 10 includes a compressor 20, a condenser 22, a condenser fan 24, an evaporator 26, an evaporator fan 28, and a controller in operative communication with some or all of the other components of the TRU system 10.

The condenser 22 is operatively coupled to a discharge port of the compressor 20. The evaporator 26 is operatively coupled to an input port of the compressor 20. An expansion valve 40 can be connected between an output of the condenser 22 and an input of the evaporator 26. The condenser fan 24 is positioned to direct an air stream onto the condenser 22. The air stream from the condenser fan 24 allows heat to be removed from refrigerant circulating within the condenser 22. The evaporator fan 28 is positioned to direct an air stream onto the evaporator 26. The evaporator fan 28 is located and ducted so as to circulate the air contained within the enclosed volume of the container 12. In one embodiment, the evaporator fan 28 can direct the stream of air across the surface of the evaporator 26. Heat can thereby be removed from the air, and the reduced temperature air can be circulated within the enclosed volume of the container 12 to lower the temperature of the enclosed volume.

The compressor 20 is powered by an engine 32, such as a diesel engine, via a generator 34 (e.g., diesel generator) operatively coupled to the engine 32. Other components of the TRU system 10 may also be powered by the generator 34. More particularly, the compressor 20 is driven by an electric motor 50 that is powered by the generator 34. The electric motor 50 may be disposed internally within the compressor 20 with a drive shaft interconnected with a shaft of the compressor 20, the components sealed within a common housing of the compressor 20.

To augment the power of the engine 32, an air chilling system is provided to counter power losses associated with elevated inlet air temperatures. The engine 32 receives an inlet air stream 52 provided to the engine 32 and the evaporator 26. An inlet structure 54 is disposed upstream of the engine 32. The inlet structure 54 includes at least one coil arrangement disposed therein that exchanges heat with the inlet air stream 52. The refrigerant that flows through the above-described refrigeration cycle is provided to the coil arrangement within the inlet structure 54 to cool the inlet air stream 52. The cooling of the inlet air stream 52 increases the power output of the engine 32.

The refrigerant is provided through the refrigeration cycle tubing. In a first embodiment (FIG. 1), the refrigerant is selectively distributed to the evaporator 26 and the engine 32 in a diverting manner. In particular, the refrigerant is separated into a first stream 60 that is routed to an evaporator inlet and a second stream 62 that is routed to the inlet structure 54. An inlet coil modulation valve 56 is disposed upstream of the inlet structure 54 to determine how much, if any refrigerant is diverted away from the evaporator 26 to the inlet structure 54 for inlet air stream cooling. If moderate ambient conditions, cooling may not be required and the inlet coil modulation valve 56 may be closed.

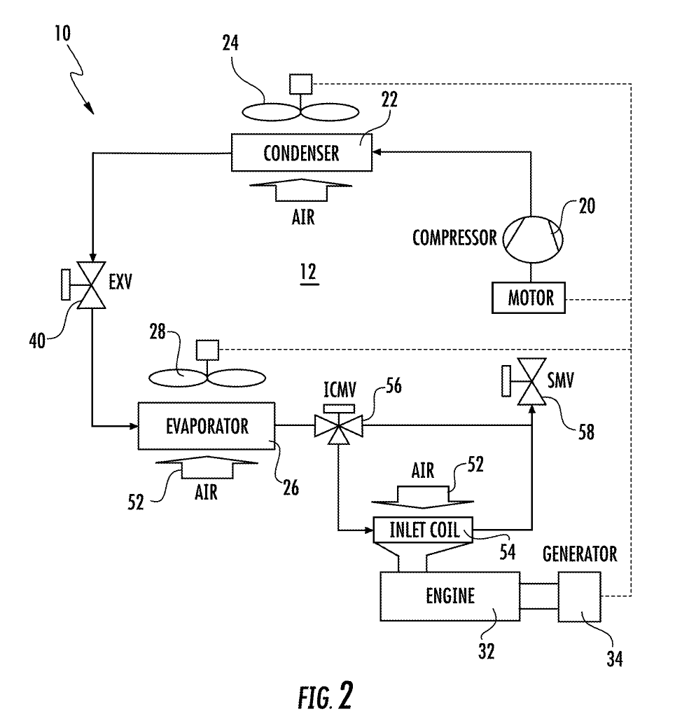

In the embodiment of FIG. 2, the evaporator 26 receives the entire flow of the refrigerant and the selective determination of whether refrigerant is flowed to the inlet structure 54 is made downstream of the evaporator 26, as shown with placement of the inlet coil modulation valve 56 in FIG. 2.

The embodiments described herein may also rely on use of one or more suction modulation valves 58 located upstream of the compressor 20 to selectively manipulate flow into the compressor 20. In some embodiments, use of only cooling of the inlet air stream 52 at the inlet structure 54 is solely sufficient to effect desirable operation of the system, however, the suction modulation valves 58 may be relied upon to supplement such cooling in certain conditions.

Advantageously, cooling of the inlet air stream 52 provided by the embodiments described herein reduce the engine design capacity and improve the system efficiency by minimizing the usage of the suction modulation valve(s).

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A transport refrigeration unit comprising:
a refrigeration cycle having a refrigerant routed therethrough, the refrigeration cycle including a compressor, a condenser, an evaporator and an expansion valve;
an engine operatively coupled to a generator to power the compressor;
an inlet structure receiving an inlet air stream for routing to the engine; and
a cooling coil arrangement disposed within the inlet structure, the refrigerant of the refrigeration cycle selectively routed through the cooling coil arrangement to cool the inlet air stream.

2. The transport refrigeration unit of claim 1, wherein the refrigerant is separated into a first stream and a second stream upstream of an evaporator inlet, the first stream routed to the evaporator and the second stream routed to the inlet structure.

3. The transport refrigeration unit of claim 2, wherein the ratio of the first stream to the second stream is selectively determined by operation of an inlet coil modulation valve disposed upstream of the inlet structure.

4. The transport refrigeration unit of claim 1, wherein all of the refrigerant is routed to an evaporator inlet and the refrigerant expelled from an evaporator outlet is routed to the inlet structure.

5. The transport refrigeration unit of claim 4, further comprising an inlet coil modulation valve disposed between the evaporator outlet and the inlet structure to regulate an amount of refrigerant routed to the inlet structure.

6. The transport refrigeration unit of claim 1, wherein the compressor is directly driven by an electric motor, the electric motor powered by the generator.

7. The transport refrigeration unit of claim 1, further comprising at least one suction modulation valve disposed between an evaporator outlet and a compressor inlet.

8. The transport refrigeration unit of claim 7, wherein the at least one suction modulation valve is only operated as a supplement during cooling of the inlet air stream.

9. The transport refrigeration unit of claim 1, wherein the generator powers a condenser fan and an evaporator fan.

10. A method of operating a transport refrigeration unit comprising:
powering a compressor of a refrigerant cycle with a generator driven by an engine;
ingesting an inlet air stream into the engine; and
cooling the inlet air stream with a refrigerant flowing through a cooling coil arrangement disposed within an inlet structure disposed upstream of the engine.

11. The method of claim 10, further comprising regulating the flow of the refrigerant to the inlet structure with an inlet coil modulating valve disposed upstream of the inlet structure.

12. The method of claim 10, further comprising separating the refrigerant into a first stream and a second stream upstream of an evaporator, the first stream routed to the evaporator and the second stream routed to the inlet structure.

13. The method of claim 10, further comprising routing all of the refrigerant to an evaporator and the refrigerant expelled from an evaporator outlet is routed to the inlet structure.

14. The method of claim 10, wherein the compressor is directly driven by an electric motor powered by the generator.
